(19) United States
(12) Patent Application Publication
(10) Pub. No.: US 2011/0320225 A1
(43) Pub. Date: Dec. 29, 2011

(54) METHOD AND APPARATUS FOR AUTOMATIC HEALTHPLAN DATA RETRIEVAL AND RECONCILIATION USING A PROCESSING DEVICE

(75) Inventors: Timothy D. Hulsey, Woodbine, MD (US); Andrew T. Hulsey, Sherwood Forest, MD (US)

(73) Assignee: STRATEGIC HEALTHPLAN SERVICES, LLC, Annapolis, MD (US)

(21) Appl. No.: 13/162,721

(22) Filed: Jun. 17, 2011

Related U.S. Application Data
(60) Provisional application No. 61/356,333, filed on Jun. 18, 2010.

(51) Int. Cl. G06Q 40/00

(52) U.S. Cl. 705/4

(57) ABSTRACT

A method and apparatus for automatic healthplan data retrieval and reconciliation using a processing device is disclosed. The method may include retrieving accounting data, human resources data and health insurance data, comparing the accounting data, the human resources data and the health insurance data, identifying discrepancies between the accounting data, the human resources data and the health insurance data, and outputting the identified discrepancies to a user. The accounting data, human resources data and health insurance data pertain to individual employees' healthplans, and the identified discrepancies are related to enrollment, coverage and payment of healthplans.

### PRIORITY INFORMATION

This non-provisional application claims priority from U.S. Provisional Patent Application Ser. No. 61/356,333, filed Jun. 18, 2010, the content of which is incorporated herein by reference in its entirety.

### BACKGROUND OF THE DISCLOSED EMBODIMENTS

1. Field of the Disclosed Embodiments

The disclosed embodiments relates to automatic healthplan data retrieval and reconciliation using a processing device.

2. Introduction

Healthplan discrepancies in companies of all sizes may needlessly cost the company thousands of dollars a month if not identified and corrected in a timely manner. For example, if the company is paying for premiums of terminated or non-participating employees, or employees are covered by an insurance company but the company is not paying premiums or is paying incorrect premiums due to a change in the employees plan or status, the company could be losing substantial money. Currently, there is no process for tracking, consolidating and reconciling healthplan data as it relates to premium payments, employee contribution through payroll deductions, plan enrollment data, status of dependent eligibility, and identifiable qualifying events that trigger changes in the required payments and coverage of employees so that needed changes can be presented to management in real-time, allowing discrepancies in the data to be identified and corrected in an efficient and timely manner.

### SUMMARY

A method and apparatus for automatic healthplan data retrieval and reconciliation using a processing device is disclosed. The method may include retrieving accounting data, human resources data and health insurance data, comparing the accounting data, the human resources data and the health insurance data, identifying discrepancies between the accounting data, the human resources data and the health insurance data, and outputting the identified discrepancies to a user. The accounting data, human resources data and health insurance data pertain to individual employees' healthplans, and the identified discrepancies are related to enrollment, coverage and payment of healthplans.

### BRIEF DESCRIPTION OF THE DRAWINGS

FIG. 1 is an exemplary diagram of a healthplan management environment in accordance with one possible embodiment of the disclosure;

FIG. 2 is an exemplary block diagram of a healthplan management unit in accordance with one possible embodiment of the disclosure;

FIG. 3 is flowchart of a healthplan management process in accordance with one possible embodiment of the disclosure;

FIGS. 4A-4E represent exemplary data received by the healthplan management unit from various data sources in accordance with one possible embodiment of the disclosure; and

FIG. 5 represents an exemplary detailed summary charts output by the healthplan management unit as a result of the data received from the various data sources in accordance with one possible embodiment of the disclosure.

### DESCRIPTION OF THE DISCLOSED EMBODIMENTS

Additional features and advantages of the disclosed embodiments will be set forth in the description which follows, and in part will be obvious from the description, or may be learned by practice of the disclosed embodiments. The features and advantages of the disclosed embodiments may be realized and obtained by means of the instruments and combinations particularly pointed out in the appended claims. These and other features of the present disclosed embodiments will become more fully apparent from the following description and appended claims, or may be learned by the practice of the disclosed embodiments as set forth herein.

Various embodiments of the disclosed embodiments are discussed in detail below. While specific implementations are discussed, it should be understood that this is done for illustration purposes only. A person skilled in the relevant art will recognize that other components and configurations may be used without parting from the spirit and scope of the disclosed embodiments.

The disclosed embodiments comprise a variety of embodiments, such as a method and apparatus and other embodiments that relate to the basic concepts of the disclosed embodiments. Note that while this disclosure discusses healthplan uses for the disclosed embodiments, the disclosed embodiments by no means limited to that area and may be applied to a wide variety of environment and uses. In particular, the disclosed embodiments may be applied to other benefit areas of a business entity, such as pension plans, 401K/retirement plans, disability insurance, life insurance, daycare allowance, mobile phone reimbursement and expenses, home office expenses, etc. The disclosed embodiments may concern the implementation of a method and apparatus for automatic healthplan and healthplan cost related data retrieval and reconciliation using a processing device. In particular, a method and apparatus for automatic healthplan data retrieval and reconciliation using a processing device that may include retrieving accounting data, human resources data and health insurance enrollment and cost data, wherein the accounting data, human resources data and health insurance enrollment and cost data pertain to public and private entity sponsored healthplans, comparing the accounting data, the human resources data and the health insurance enrollment and cost data, identifying discrepancies between the accounting data, the human resources data and the health insurance enrollment and cost data, wherein the identified discrepancies are related to enrollment, coverage and payment of healthplan related costs such as administrative expenses and premiums, providing business intelligence, model forecasting, and projected changes in healthplan cost and coverage benefits through data visualization, by allowing the user to enter and assess scenarios based on proposed business decision or changes in the healthcare mandates under Federal and State Legislation; and outputting the identified discrepancies, reports, models, and projections to a user.

The disclosed embodiments may involve two processes, namely a Healthplan Administration Reconciliation Program (hereinafter “HARP”), and/or an on-going Healthplan Administration and Real-time Data Reconciliation Platform for Cost Management (hereinafter “HARDCOST Platform”), that may work together to identify areas where companies can improve the efficiency of their internal healthplan administration, save money on existing healthplans, and reduce exposure to potential legal liabilities. These processes will be discussed in detail below.

I. Healthplan Administration Reconciliation Program (Hereinafter “Harp”)—Business Process

Summary—The HARP Process may be a business process designed to save companies money on the internal administration of corporate and governmental entities healthplans by collecting, comparing, and reconciling multiple raw sources of data to identify inconsistencies, errors, process inefficiencies, potential liabilities, and areas for potential improvement to increase efficiency in administering a corporate or government entity's healthplan. In essence, the process may assist and educate companies and entities so the responsible parties can more efficiently and cost effectively handle their healthplan related data, more easily administer their current healthplan(s), improve managerial oversight of expenses, improve their healthplan system capabilities, save money, plan for adjustments of healthplan related expenses based on business decisions and model forecasting, and generally reduce exposure to potential legal liabilities.

Technical Components—The HARP Process of reconciliation may be commenced through importation of data or through the use of the Healthplan Administration and Real-time Data Reconciliation Platform for Cost Management (hereinafter “HARDCOST Platform”), as more fully described below in §II. Data fields that may need to be populated for the process to be completed and effective may include, but are not limited to, employees' subscriber enrollment forms showing elected plan coverage, employer coverage contract with the provider/insurance carrier showing the negotiated fee schedule, payroll deduction reports showing actual withholdings from paychecks, a deduction table showing appropriate deductions for selected coverage, and past provider/insurance carrier invoices showing the detailed cost breakdown for coverage by employee. Once the data fields are populated, the process may reconcile the collected information to identify inconsistencies, areas for potential improvement for internal plan administration, and generally increase managerial oversight by creating greater transparency into healthplan related cost.

Reports Generated—The HARP Process may generate reports, as desired, that provide model forecasting of potential fluctuation of healthplan expenses that would result from business decisions, identify inconsistencies (hereinafter “inconsistencies”) where in the process of internal administration of an entity's healthplan there has been waste, over-billing, exposure to potential legal liabilities, inequalities in employee coverage, areas were the entity can save money and improve the process and make more efficient their internal healthplan administration. A non-exhaustive list of potential inconsistencies may include:

Payroll deduction report (hereinafter “PR DED”) that may show unequal amounts of withholdings for employees who have selected the same type of coverage;

PR DED that may show that employees who have coverage, and are receiving coverage paid by the company, are inappropriately not having funds withheld from their paychecks;

Persons, perhaps former employees, may be receiving coverage, the company is being billed by the insurance carrier, and the person is not on the payroll register;

Part-time employees may be inappropriately receiving full coverage by insurance carrier but have lower deduction amounts per the PR DED;

Employee's Subscriber Enrollment Form (hereinafter “SEF”) may show that a different plan was selected than the coverage being provided by the provider/insurance carrier according to carrier invoices;

Employee's SEF elected coverage for spouses and/or dependents that may not be receiving coverage according to the insurance carrier invoices;

Company may be billed by carrier and paying for coverage for Employee(s) and/or Spouses and/or Dependants, where all coverage has been waived by Employee and there is no correlating SEF; and,

Employees may have completed and selected coverage having completed an SEF, are having money withheld on paychecks, but are not receiving coverage per insurance carrier invoices (hereinafter “ICI”).

II. Healthplan Administration and Real-Time Data Reconciliation Platform for Cost Management (Hereinafter “HARDCOST Platform”) Process

Summary—The HARDCOST Platform Process may be a platform, system and/or method designed to provide real-time healthplan data reconciliation to improve financial management, oversight and decision forecasting for use by private and public sector entities. In an illustrative implementation, the system may be downloadable from a web site, purchased as stored on a computer-readable medium, and/or as a web-hosted platform.

The process may process healthplan administration data reconciliation utilizing a rules engine that is interoperable with any data sets/forms from existing or newly created data systems used by human resources, benefits plan administrators, healthcare providers, accounting and payroll, insurance carrier and payment processing providers, and any other relevant data sets to generate plan status and performance, by reporting, alerting and conveying business intelligence to the end-users through a dashboard. The system and platform may support real-time and ongoing process improvements by streamlining and creating efficiencies in data collection, correlation, reconciliation, reporting, usability and output. The system and platform may be dynamic and scalable to enable input of additional data sets to manage changes in relevant policy/plan-holder information, federal and state healthcare-related policy changes, administrative rules, and other data sets to enhance management, cost containment and decision making/forecasting.

Technical Specifications—The process data fields may be initially populated by manual import during commencement of the HARP Processor can be electronically populated using smart middle ware to electronically capture the raw data sources. The process may contain an adjustable Master Table that may act as a template for typical internal corporate policies related to internal healthplan administration. The Master Table is adjusted at the time of software installation and data field population to establish and reflect an entity's withholding policies for employees selecting coverage, the manner by which Human Resources enrolls and removes coverage, and the internal billing and payment process used by accounting to receive and pay provider/carrier invoices. The process may contain Secondary Adjustable Tables that may be updatable to accurately reflect the coverage rates as negotiated with the provider/insurance carrier and percentages of employee contribution withholdings. The process may proactively capture in real-time, information from the existing or newly-created systems used by Human Resources, Accounting, and the Provider/Insurance Carrier, and maps that data to the appropriate data field in the established Master and Secondary Tables. The Master and Secondary Tables may then reconcile the correlating data fields to identify were in the process of internal administration of the company healthplan there has been waste, overpayment, incorrect coverage, exposure to potential legal liabilities, inequalities, and/or any other inaccuracy in the internal administration of the company healthplan.

The process may constantly and consistently interface with and information systems that act as sources for data field populations and format that data so it can be instantaneously updated reconciled on a continuous basis. In this manner, the process may simulate/clones a company's existing HRIS capabilities and utilizes the uploaded data to make it more useful and user-friendly in real-time.

Generated Results—In addition to the Reports Generated as described above, the process may provide alerts and notifications in real-time to Human Resources, Accounting, and the Provider/Insurance Carrier when one data field is inconsistent, thus identifying a flaw in a company's internal healthplan administration. The process may immediately notify users of all the inconsistencies discussed above. Additionally, the process may show in real-time, on a dashboard accessible to Company/Entity Management, Human Resources, Accounting, and the Provider/Insurance Carrier a variety of events, including, but not limited to:

Changes in open enrollment;

Qualifying events (i.e. a birthday making a dependant ineligible);

Inequalities or special arrangements within the healthplan;

Varying payment terms and/or deduction agreements;

Immediate reconciliation and cessation of benefits following terminations;

Improper delays in removing coverage for termed employees;

Discrepancies between original selected coverage presently withheld amounts from payroll; and,

Mistakenly equally deducted amounts from various employees who have selected different types of coverage.

Alternate Data Hosting—the process may be created to be sold as either an off the shelf product or as a service hosted off-site and remotely accessible via the internet, for example.

The real-time or on-demand functionality of the healthplan management unit may provide total situational awareness of current enrollees, associated costs, and prevents any miscommunication between Human Resources, Accounting, Insurance Brokers, and Providers; thereby eliminating corporate waste as it relates to internal healthplan administration and significantly reducing a company's exposure to legal liabilities.

The healthplan reconciliation unit may enable the user to generate healthplan related business intelligence for healthplan cost situational awareness and financial modeling, and generates custom reports that include data visualization to support real-time and future decision forecasting by management, accounting, human resources, among others. Users with approved access may utilize the decision forecasting tools to help managers better understanding healthcare related expenses, including the cost of increased/decreased subscribers on the company plan, rate changes impact, healthplan demographics, effectiveness of plan changes and wellness programs, and other intelligence of relevance to healthplan management.

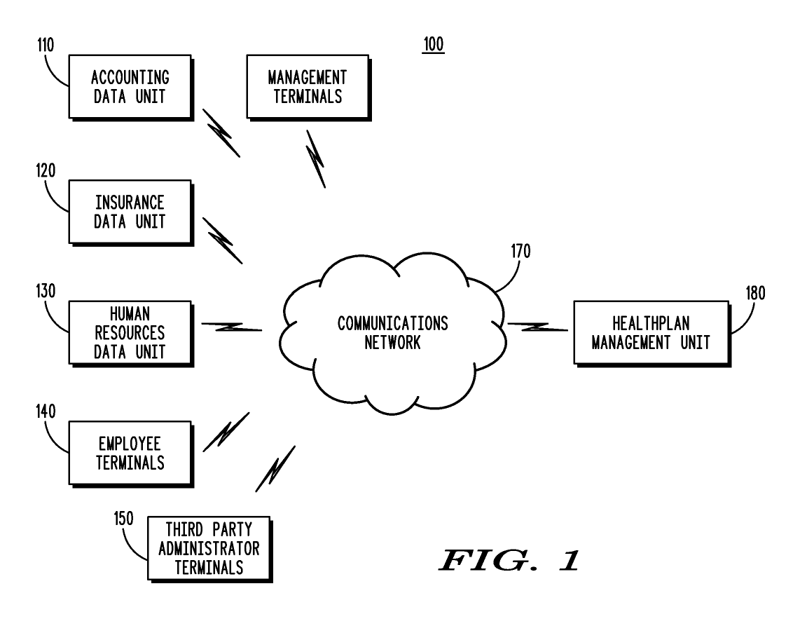

FIG. 1 is an exemplary diagram of a healthplan management environment 100 in accordance with one possible embodiment of the disclosure. The healthplan management environment 100 may include one or more accounting data units 110, insurance data units 120, human resources data units 130, employee terminals 140, third party administrator terminals 150, management terminals 160, and a healthplan management unit 180 connected through the communications network 170.

The healthplan management unit 180 may be a server, computer, handheld computer or processing device, for example. The communications network 170 may represent any communication, such as the Internet, intranet, telephone network, cable television network, satellite television network, satellite radio network or any other network system through which data may be retrieved or received as known to one of skill in the art, for example. The connections shown in FIG. 1 are two-way so that certain data may be sent or received between the healthplan management unit 180 and the one or more accounting data units 110, insurance data units 120, human resources data units 130, employee terminals 140, third party administrator terminals 150, and management terminals 160. While the connections shown in FIG. 1 are wireless, this is exemplary and as such, the connections maybe hardwired, for example. Furthermore, any of the one or more accounting data units 110, insurance data units 120, human resources data units 130, employee terminals 140, third party administrator terminals 150, or management terminals 160 may communicate directly with the healthplan management unit 180 and not through the communications network 170, for example.

The one or more accounting data units 110, insurance data units 120, human resources data units 130, employee terminals 140, third party administrator terminals 150, and management terminals 160 may represent servers, computers, or any other processing devices, and that may access stored data from memory devices and communicate that data to the healthplan management unit 180 or receive data from the healthplan management unit 180.

The healthplan management unit 180 may include the computer/server systems and software that may be standalone or part of a larger business management unit used by an employer for management of business operations, for example. The healthplan management unit 180 may be a local processing device, server, computer, etc. storing the software to implement the healthplan management process, or may be a remotely located processing device, server, computer, etc. that make be web-based, application-based, etc., and accessed through the communications network 170, for example.

The accounting department data source 110 may contain typical information and data held by a company's accounting department related to employee healthplan coverage, such as reports showing the amount of deductions withheld from paychecks to pay for employee portions of healthplan coverage. The insurance data unit 120 may represent a typical insurance provider data as it relates to employee healthplan coverage, such as carrier invoices listing types of elected coverage and class type. The human resources data unit 130 may contain human resources data as it pertains to employee healthplan coverage, such as the subscriber enrollment forms, for example.

The employee terminals 140, third party administrator terminals 150, and management terminals 160 may represent computers, servers, or processing devices (including handheld mobile processing devices) used to access and send data from and to the healthplan management unit 180. The healthplan management unit 180 may grant only certain access to data (and/or the ability to change certain data) and discrepancy information to particular entities, such as accounting, insurance carriers, human resources, employees, third party administrators, and management. For example, employees may be granted access to view their insurance data for any discrepancy related just to them, but be denied access to other data. At least one of the third party administrator may have access to all (or many data sets) of the data, for example. The management (e.g., CEO/Owner) may have access to most or all of the data, for example, but will only be able to view certain fields without the authority to alter those fields.

The healthplan management unit 180 may be a platform that receives, normalizes, and compares multiple forms and sources of data to identify inconsistencies, errors, and potential process improvements. The healthplan management unit 180 may store the data and relays information in near real time to the information sources.

The healthplan management unit 180 may be a platform that may fit in relation to the typical business entity approach to internal healthplan administration. In particular, the healthplan management unit 180 may be designed to provide near real-time healthplan data reconciliation to improve financial management, oversight and decision forecasting for use by private and public sector entities.

The healthplan management unit 180 may process healthplan administration data reconciliation utilizing a rules engine that is interoperable with any data sets/forms from existing systems used by human resources, benefits plan administrators, healthcare providers, accounting and payroll, insurance carrier and payment processing providers, and any other relevant data sets to generate plan status and performance, by reporting, alerting and conveying business intelligence to the end-users through a dashboard. The healthplan management unit 180 may support real-time and ongoing process improvements by streamlining and creating efficiencies in data collection, correlation, reconciliation, reporting, usability and output. The healthplan management unit 180 may be dynamic and scalable to enable input of additional data sets to manage changes in relevant policy/plan-holder information, federal and state healthcare-related policy changes, administrative rules, and other data sets to enhance management, cost containment and decision making/forecasting.

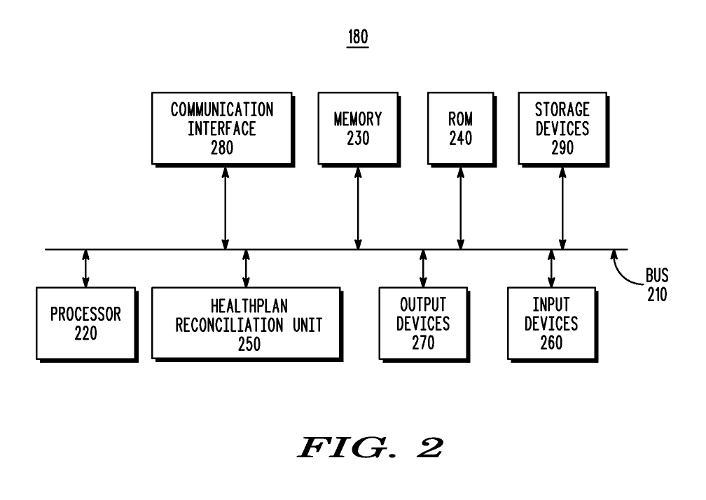

FIG. 2 is an exemplary block diagram of a healthplan management unit 180 in accordance with one possible embodiment of the disclosure. The healthplan management unit 180 may include a bus 210, a processor 220, a memory 230, a read only memory (ROM) 240, a healthplan reconciliation unit 250, input devices 260, output devices 270, a communication interface 280, and storage device 290. Bus 210 may permit communication among the components of the healthplan management unit 180.

Processor 220 may include at least one conventional processor or microprocessor that interprets and executes instructions. The memory 230 may be a random access memory (RAM) or another type of dynamic storage device that stores information and instructions for execution by processor 220. The memory 230 may also include a read-only memory (ROM) 240 which may include a conventional ROM device or another type of static storage device that stores static information and instructions for processor 220.

Input devices 260 may include one or more conventional mechanisms that permit a user to input information to the healthplan management unit 180, such as a keyboard, a mouse, a pen, a voice recognition device, etc. Output devices 270 may include one or more conventional mechanisms that output information to the user, including a display, a printer, one or more speakers, or a medium, such as a memory, or a magnetic or optical disk and a corresponding disk drive.

Communication interface 280 may include any mechanism that facilitates communication via a network. For example, the communication interface 280 may include a modem. Alternatively, communication interface 280 may include other mechanisms for assisting in communications with other devices and/or systems.

ROM 240 may include a conventional ROM device or another type of static storage device that stores static information and instructions for processor 220. The storage devices 250 may augment the ROM 240 and may include any type of storage media, such as, for example, magnetic or optical recording media and its corresponding drive.

The healthplan management unit 180 may perform such functions in response to processor 220 by executing sequences of instructions contained in a computer-readable medium, such as, for example, the memory 230. Such instructions may be read into the memory 230 from another computer-readable medium, such as a storage device or from a separate device via communication interface 280.

The healthplan management unit 180 illustrated in FIGS. 1-2 and the related discussion were intended to provide a brief, general description of a suitable communication and processing environment in which the disclosure may be implemented. Although not required, the disclosure will be described, at least in part, in the general context of computer-executable instructions, such as program modules, being executed by the healthplan management unit 180, which may be a server, a computer, a handheld computer, and a processing device, for example.

Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including personal computers, hand-held devices, multi-processor systems, microprocessor-based or programmable consumer electronics, and the like.

In operation, the healthplan reconciliation unit 250 may electronically capture, has downloaded, or receive raw source data from the one or more accounting data units 110, insurance data units 120, human resources data units 130 and may normalize that data into a form that may be stored and maintained in memory 230. The memory 230 may include at least three modules (or databases) for storage for each respective source of data and stored master and secondary rate tables that may compare, reconcile, and interrelate the data in real-time to identify any inconsistencies in the data.

The healthplan reconciliation unit 250 may generate information for presentation to, and receive information from, the end-user through a dashboard. The healthplan reconciliation unit 250 may also revert the reconciled data to raw data and send the reconciled raw data through the communication interface to either of the one or more accounting data units 110, insurance data units 120, human resources data units 130.

Once the data is received and reconciled in the healthplan reconciliation unit 250 and stored in the memory 230, the end user may or may not elect to use the previously existing stored data for the internal administration of the employees' healthplans. As the data is changed either through the one or more accounting data units 110, insurance data units 120, human resources data units 130, or by end-user input through the dashboard, for example, the healthplan reconciliation unit 160 may reconcile the information and make updates in real-time and proactively notify all end-users of non-consistency amongst the data set and make appropriate recommendations.

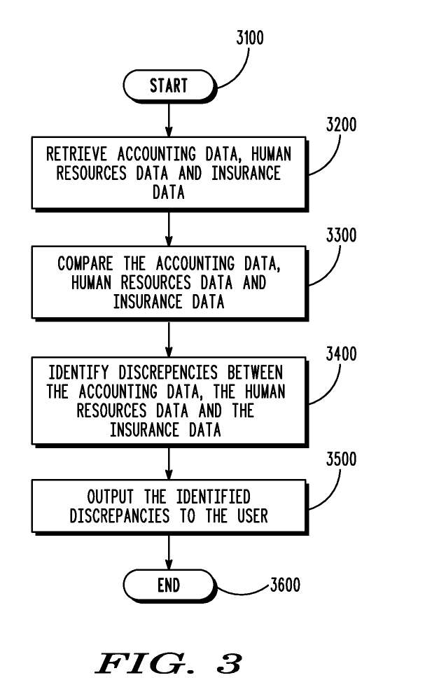

The operation of the healthplan reconciliation unit 250 and the healthplan management process will be discussed below in relation to the flowchart in FIG. 3

FIG. 3 is flowchart of a healthplan management process in accordance with one possible embodiment of the disclosure. The process may begin at step 3100 and may continue to step 3200 where the healthplan reconciliation unit 250 may retrieve accounting data, human resources data and health insurance data through the communication interface 280. As discussed in detail above, the accounting data, human resources data and health insurance data may pertain to individual employees' healthplans, for example.

The human resources data may include at least one of employee identification information, employment status, healthplan enrollment status, healthplan identification, healthplan type, and dependent information, for example. The accounting data may include at least one of employee identification information, employment status, an amount of payroll deductions for employees' healthplans, type of healthplan for which payroll deductions are made, and an amount of an employer's contribution to the employee's healthplan, for example. The health insurance data may include at least one of employee identification information, employment status, an amount charged for employees' healthplans, type of healthplan for the amount charged, number of dependents covered under the employees selected coverage type, and an amount of an employer's contribution to the employee's healthplan, for example.

At step 3300, the healthplan reconciliation unit 250 may compare the accounting data, the human resources data and the health insurance data. At step 3400, the healthplan reconciliation unit 250 may identify discrepancies between the accounting data, the human resources data and the health insurance data. The identified discrepancies may be related to enrollment, coverage and payment of healthplans, for example. At step 3500, the healthplan reconciliation unit 250 may output the identified discrepancies to a user. The discrepancy data may be output visually on a computer or handheld device, in the form of printed reports, or delivered to a dashboard where it is available to all end-users with predefined access for real-time and interactive use, for example. Company management, a third party administrator, a health insurance carrier, an accounting department, and a human resources department may have at least some limited visual access to at least some of the accounting data, the human resources data, the health insurance data, and the identified discrepancies, for example. The process may then go to step 3600 and end.

The healthplan reconciliation unit 250 may store employees' healthplan eligibility documents and data in the memory 230 so that the eligibility information may be retrieved and verified, for example. The eligibility may concern the employee and/or the employee's dependents and may be documents such as marriage certificates, birth certificates, or other eligibility documents, for example. The document may be paper (which is then scanned in and saved) or electronic, for example. The health insurance data, accounting data, and insurance data may include healthplan enrollment information, cost information, payroll deduction information, administrative costs and premium information.

The healthplan reconciliation unit 250 may receive proposed or actual changes to at least one of accounting data, human resources data and health insurance data and forecast healthplan-related expenses based on the proposed changes to at least one of accounting data, human resources data and health insurance data. The healthplan-related expenses being at least one of a cost of increased/decreased subscribers on an employer's healthplan, healthplan rate changes impact, healthplan demographics, effectiveness of healthplan changes, and cost of wellness programs, and outputs the forecasted healthplan-related expenses to the user. In this manner, management, accounting, and/or human resources departments may be able see the monetary impact of these changes and take appropriate action.

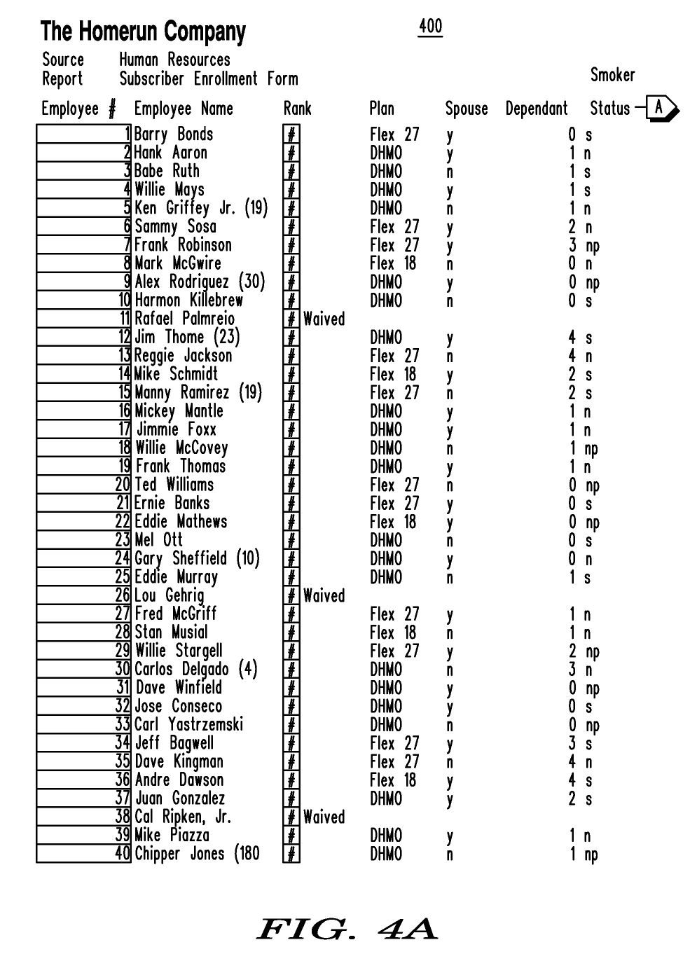

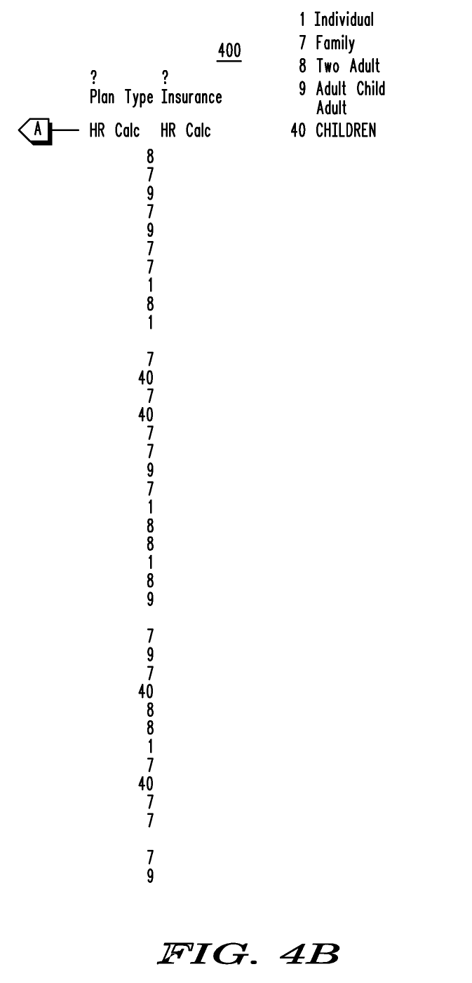

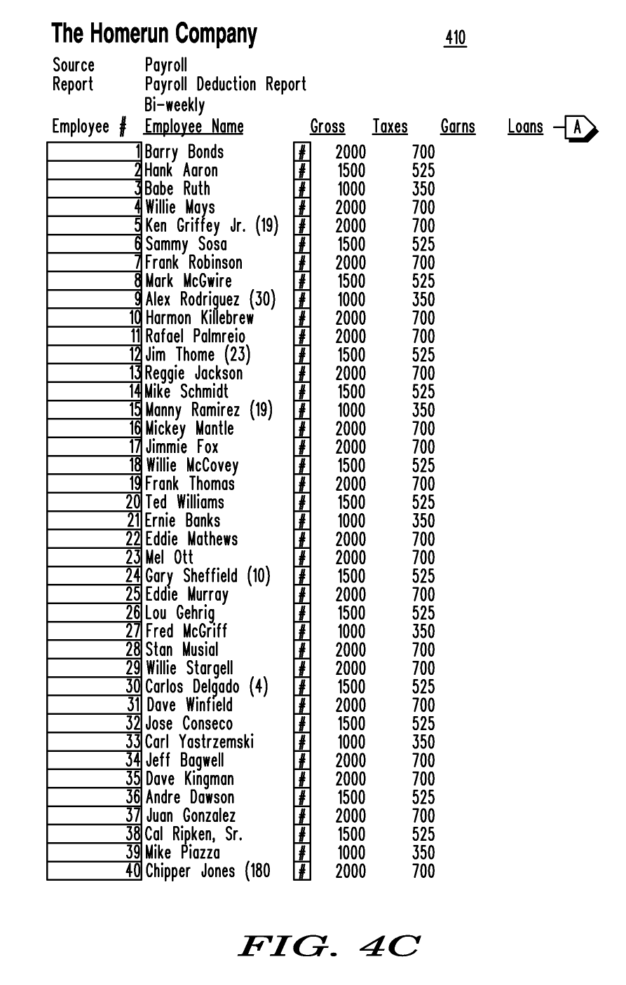

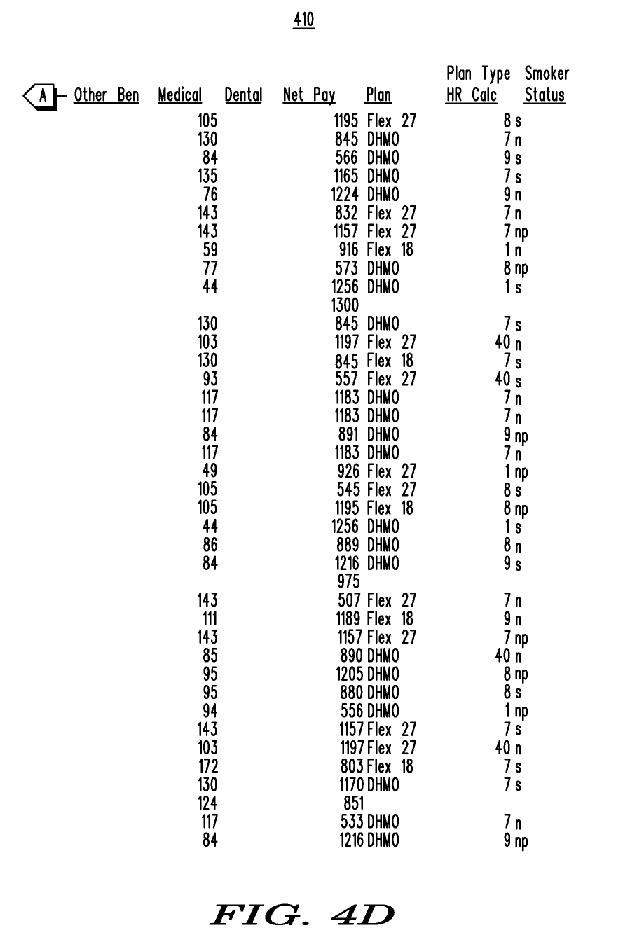

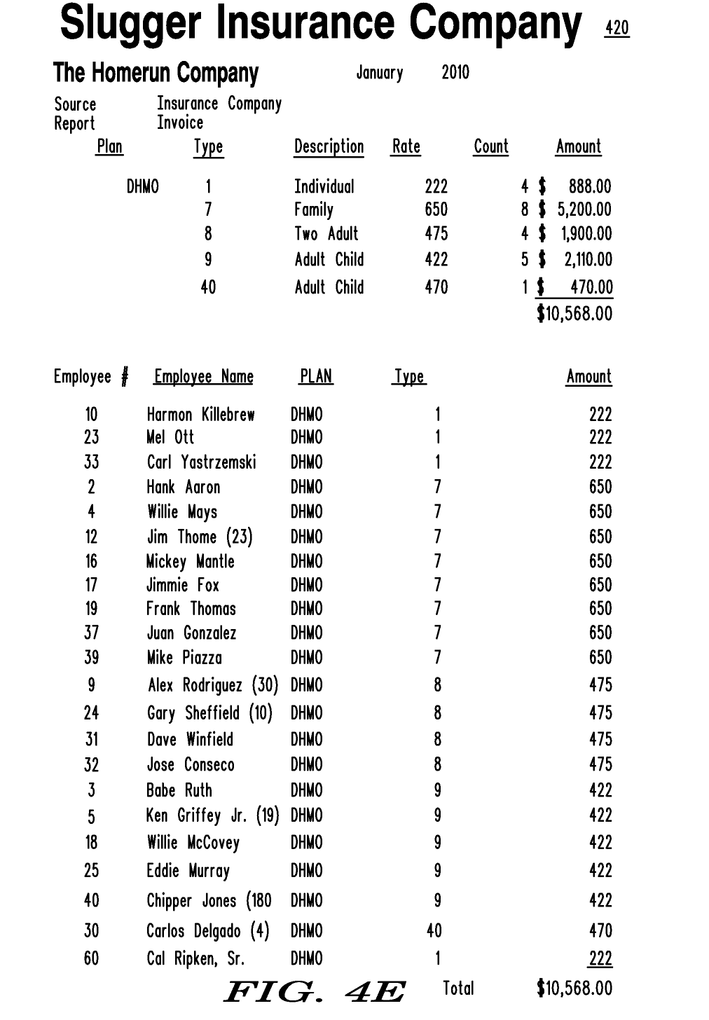

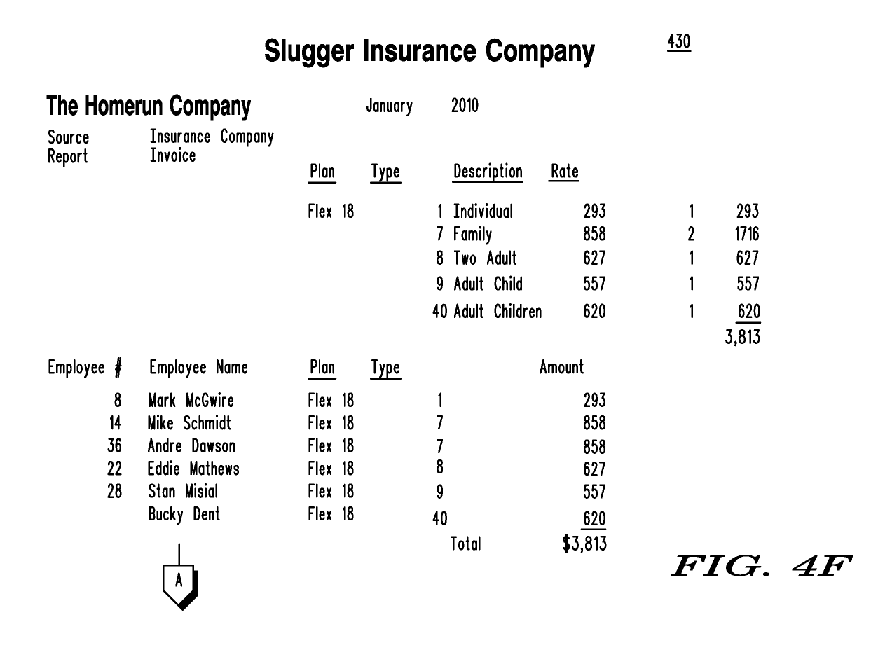

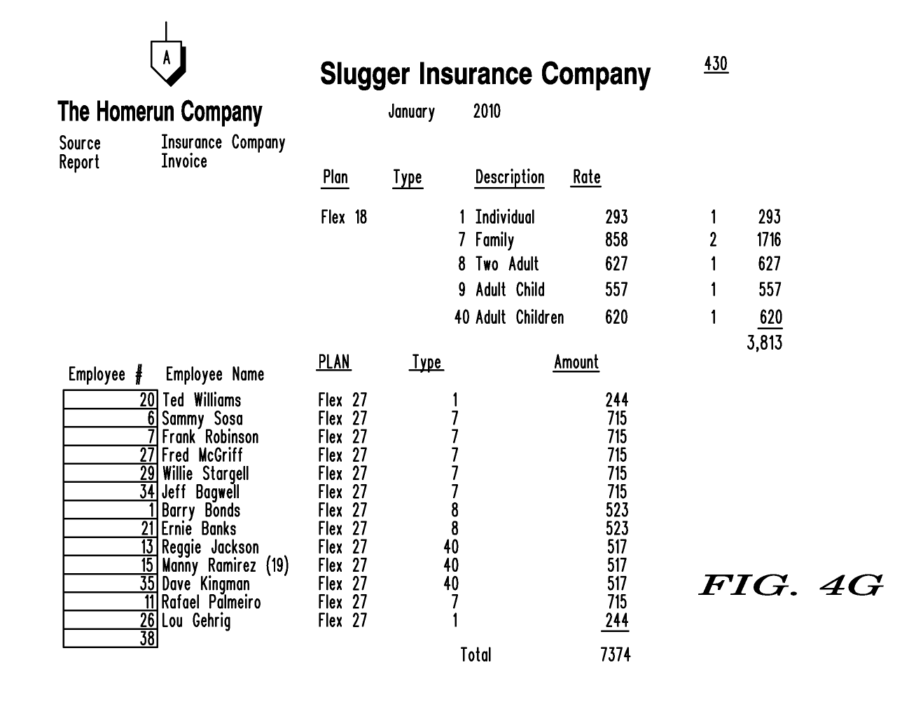

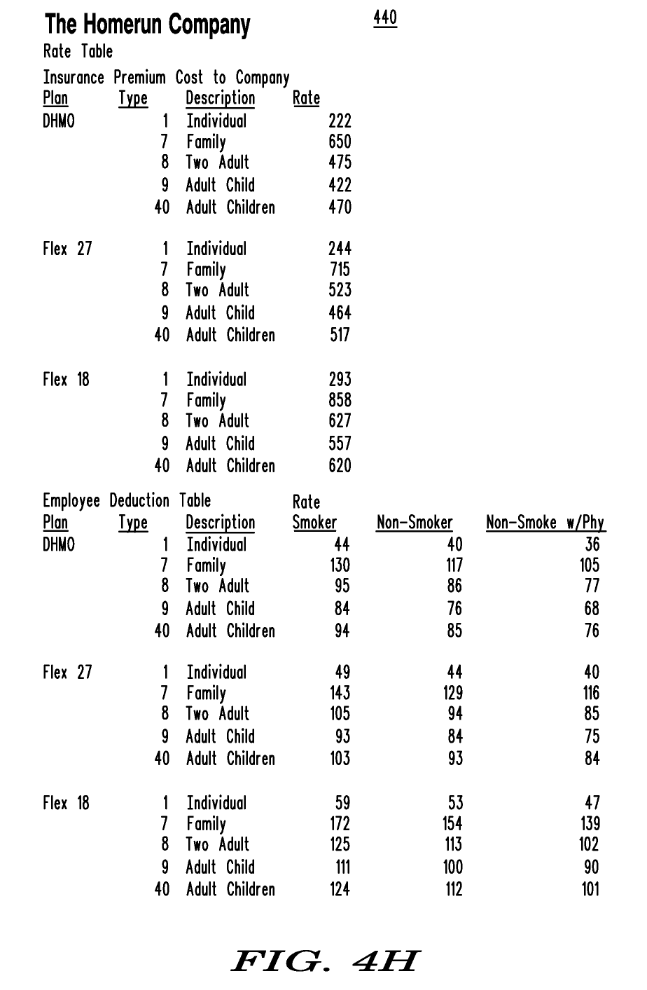

FIGS. 4A-4E represent exemplary data received by the healthplan management unit 180 from the one or more accounting data units 110, insurance data units 120, and human resources data units 130. FIG. 4A is exemplary data 400 received from the human resources data unit 130. FIG. 4B is exemplary data 410 received from the accounting data unit 110. FIGS. 4C and 4D are exemplary data 420, 430 received from the insurance data unit 120. FIG. 4E is exemplary rate table data 440 received from the insurance data unit 120.

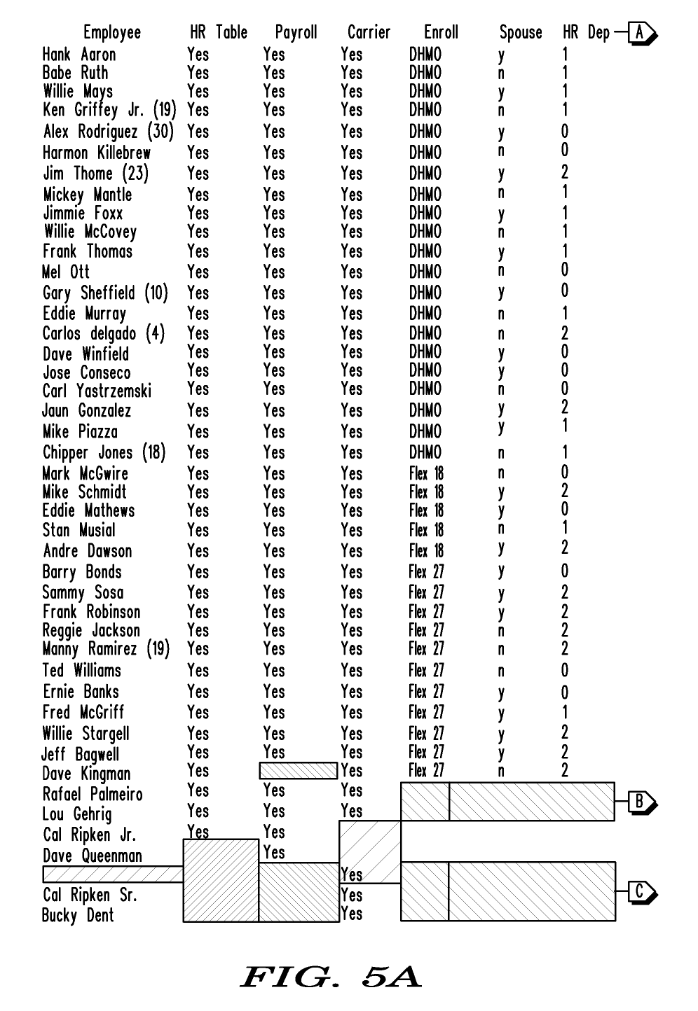

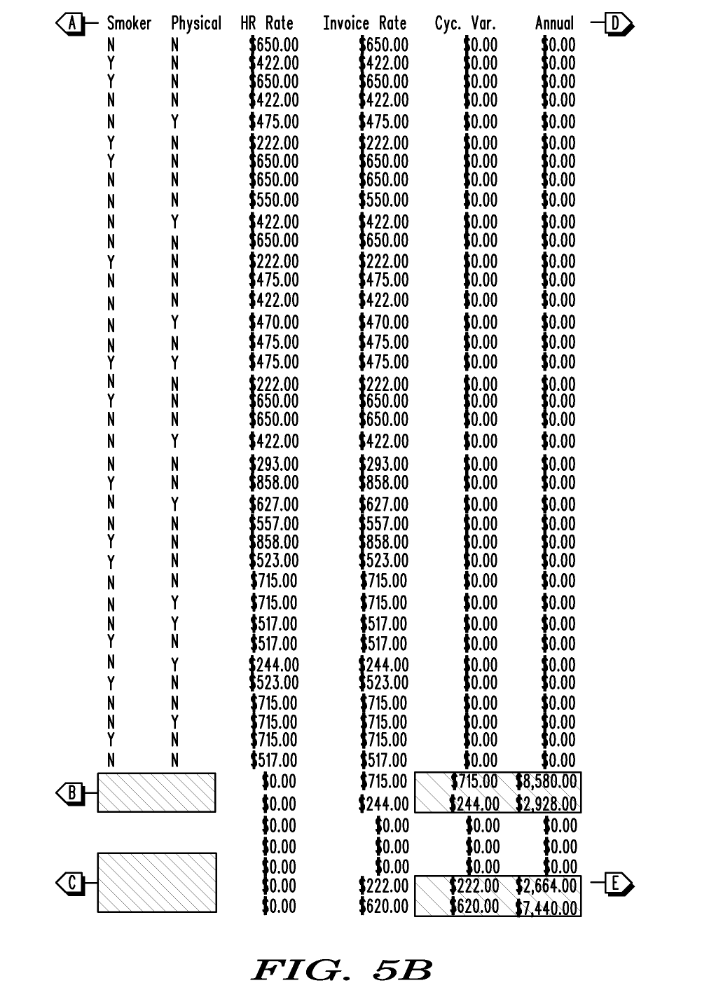

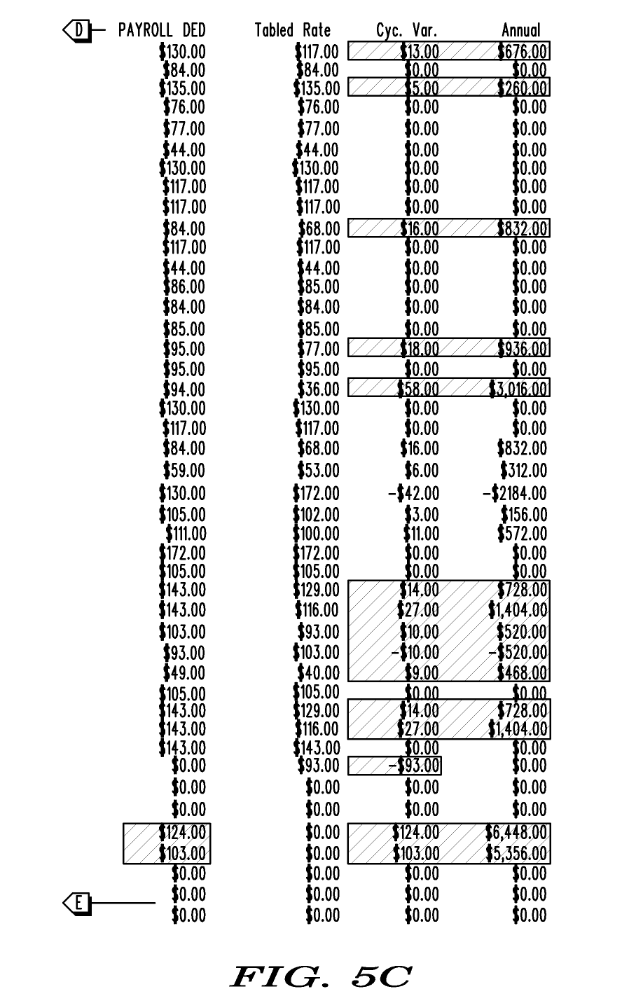

FIG. 5 represents an exemplary detailed summary charts output by the healthplan reconciliation unit 250 as a result of the data received from the one or more accounting data units 110, insurance data units 120, human resources data units 130. The summary chart 500 may identify inconsistencies that may show where the company is losing money by paying for premiums of terminated or non-participating employees, that employees are not being covered by an insurance company despite the company paying premiums, or many other possible discrepancies. The summary chart 500 may allow management to identify the problems so that they may take corrective action. The shaded areas highlight the identified discrepancies for management, accounting, human resources, or other interested party.

Embodiments within the scope of the present disclosed embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosed embodiments are part of the scope of the disclosed embodiments. For example, the principles of the disclosed embodiments may be applied to each individual user where each user may individually deploy such a system. This enables each user to utilize the benefits of the disclosed embodiments even if any one of the large number of possible applications do not need the functionality described herein. In other words, there may be multiple instances of the disclosed system each processing the content in various possible ways. It does not necessarily need to be one system used by all end users. Accordingly, the appended claims and their legal equivalents should only define the disclosed embodiments, rather than any specific examples given.

What is claimed is:

1. A method for automatic healthplan data retrieval and reconciliation using a processing device, comprising:
retrieving accounting data, human resources data and health insurance data, wherein the accounting data, human resources data and health insurance data pertain to individual employees' healthplans;
comparing the accounting data, the human resources data and the health insurance data;
identifying discrepancies between the accounting data, the human resources data and the health insurance data, wherein the identified discrepancies are related to enrollment, coverage and payment of healthplans; and
outputting the identified discrepancies to a user.

2. The method of claim 1, wherein the human resources data includes at least one of employee identification information, employment status, healthplan enrollment status, healthplan identification, healthplan type, and dependent information.

3. The method of claim 1, wherein the accounting data includes at least one of employee identification information, employment status, an amount of payroll deductions for employees' healthplans, type of healthplan for which payroll deductions are made, and an amount of an employer's contribution to the employee's healthplan.

4. The method of claim 1, wherein the health insurance data includes at least one of employee identification information, employment status, an amount charged for employees' healthplans, type of healthplan for the amount charged, and an amount of an employer's contribution to the employee's healthplan.

5. The method of claim 1, wherein the identified discrepancies are output in a report for the user.

6. The method of claim 1, wherein at least one of company management, a third party administrator, a health insurance carrier, an accounting department, and a human resources department have at least some access to at least one of the accounting data, the human resources data, the health insurance data, and the identified discrepancies.

7. The method of claim 1, wherein the processing device is one of a server, a computer, and a handheld computer.

8. The method of claim 1, further comprising:
receiving proposed changes to at least one of accounting data, human resources data and health insurance data;
forecasting healthplan-related expenses based on the proposed changes to at least one of accounting data, human resources data and health insurance data, the healthplan-related expenses being at least one of a cost of increased/decreased subscribers on an employer's healthplan, healthplan rate changes impact, healthplan demographics, effectiveness of healthplan changes, and cost of wellness programs; and
outputting the forecasted healthplan-related expenses to the user.

9. An apparatus that automatically retrieves and reconciles healthplan data, comprising:
a communication interface; and
a healthplan reconciliation unit that retrieves accounting data, human resources data and health insurance data through the communication interface, compares the accounting data, the human resources data and the health insurance data, identifies discrepancies between the accounting data, the human resources data and the health insurance data, outputs the identified discrepancies to a user,
wherein the accounting data, human resources data and health insurance data pertain to individual employees' healthplans and the identified discrepancies are related to enrollment, coverage and payment of healthplans.

10. The apparatus of claim 9, wherein the human resources data includes at least one of employee identification information, employment status, healthplan enrollment status, healthplan identification, healthplan type, and dependent information.

11. The apparatus of claim 9, wherein the accounting data includes at least one of employee identification information, employment status, an amount of payroll deductions for employees' healthplans, type of healthplan for which payroll deductions are made, and an amount of an employer's contribution to the employee's healthplan.

12. The apparatus of claim 9, wherein the health insurance data includes at least one of employee identification information, employment status, an amount charged for employees' healthplans, type of healthplan for the amount charged, and an amount of an employer's contribution to the employee's healthplan.

13. The apparatus of claim 9, wherein the healthplan reconciliation unit outputs the identified discrepancies in a report for the user.

14. The apparatus of claim 9, wherein at least one of company management, a third party administrator, a health insurance carrier, an accounting department, and a human resources department have at least some access to at least one of the accounting data, the human resources data, the health insurance data, and the identified discrepancies.

15. The apparatus of claim 9, wherein the apparatus is one of a server, a computer, a handheld computer, and a processing device.

16. The apparatus of claim 9, wherein the healthplan reconciliation unit receives proposed changes to at least one of accounting data, human resources data and health insurance data, forecasts healthplan-related expenses based on the proposed changes to at least one of accounting data, human resources data and health insurance data, the healthplan-related expenses being at least one of a cost of increased/decreased subscribers on an employer's healthplan, healthplan rate changes impact, healthplan demographics, effectiveness of healthplan changes, and cost of wellness programs, and outputs the forecasted healthplan-related expenses to the user.

17. A non-transient computer-readable medium storing instructions for controlling a processing device for automatic healthplan data retrieval and reconciliation using a processing device, the instructions comprising:
retrieving accounting data, human resources data and health insurance data, wherein the accounting data, human resources data and health insurance data pertain to individual employees' healthplans;
comparing the accounting data, the human resources data and the health insurance data;
identifying discrepancies between the accounting data, the human resources data and the health insurance data, wherein the identified discrepancies are related to enrollment, coverage and payment of healthplans; and
outputting the identified discrepancies to a user.

18. The non-transient computer-readable medium of claim 17, wherein the human resources data includes at least one of employee identification information, employment status, healthplan enrollment status, healthplan identification, healthplan type, and dependent information.

19. The non-transient computer-readable medium of claim 17, wherein the accounting data includes at least one of employee identification information, employment status, an amount of payroll deductions for employees' healthplans, type of healthplan for which payroll deductions are made, and an amount of an employer's contribution to the employee's healthplan.

20. The non-transient computer-readable medium of claim 17, wherein the health insurance data includes at least one of employee identification information, employment status, an amount charged for employees' healthplans, type of healthplan for the amount charged, and an amount of an employer's contribution to the employee's healthplan.

21. The non-transient computer-readable medium of claim 17, wherein the identified discrepancies are output in a report for the user.

22. The non-transient computer-readable medium of claim 17, wherein at least one of company management, a third party administrator, a health insurance carrier, an accounting department, and a human resources department have at least some access to at least one of the accounting data, the human resources data, the health insurance data, and the identified discrepancies.

23. The non-transient computer-readable medium of claim 17, wherein the processing device is one of a server, a computer, and a handheld computer.

24. The non-transient computer-readable medium of claim 17, further comprising:
receiving proposed changes to at least one of accounting data, human resources data and health insurance data;
forecasting healthplan-related expenses based on the proposed changes to at least one of accounting data, human resources data and health insurance data, the healthplan-related expenses being at least one of a cost of increased/decreased subscribers on an employer's healthplan, healthplan rate changes impact, healthplan demographics, effectiveness of healthplan changes, and cost of wellness programs; and
outputting the forecasted healthplan-related expenses to the user.
